(19) United States
(12) Patent Application Publication
(10) Pub. No.: US 2021/0082030 A1
(43) Pub. Date: Mar. 18, 2021

(54) METHOD AND SYSTEM FOR PROVIDING PACKAGES IN A SHOPPING ENVIRONMENT

(71) Applicant: Or-Oz Ltd., Rishon LeTsiyon (IL)

(72) Inventor: Naftali Gun, Yehud (IL)

(21) Appl. No.: 16/654,179

(22) Filed: Oct. 16, 2019

(30) Foreign Application Priority Data
Sep. 12, 2019 (IL) 269325

(51) Int. Cl. G06Q 30/06; G06K 7/14

(52) U.S. Cl. CPC G06Q 30/0635; G06K 7/1413

(57) ABSTRACT

A method and a system for packaging items in a shopping environment. One method comprises: marking a copy of an item, wherein said marking identifies the copy of the item as being associated with a customer; transferring the copy of the item to a shared intermediate zone, wherein the shared intermediate zone comprises a plurality of marked items, at least one of which is marked to be associated with another customer different than the customer; transferring items from a shared intermediate zone to a packaging zone, whereby transferring the copy of the item to the packaging zone; distributing the items from the shared intermediate zone to packages for different customers, wherein said distributing is performed based on the markings that identify customers associated with the items, wherein said distributing comprises adding the copy of the item to a package of the customer; and providing the package to the customer.

### TECHNICAL FIELD

The present disclosure relates to shopping environments.

### BACKGROUND

Shopping in supermarkets may require some physical effort. The supermarket is generally quite large, and shopping therein may include walking in plenty of aisles to look for and pick up desired goods. It is common to have a shopping cart provided for each customer to gather her selected items, instead of holding the items in her hands throughout the shopping session.

In some cases, the shopping cart is provided to the customer upon arriving to the supermarket. In other cases, the shopping cart may be owned by the customer and brought to the supermarket by her.

In addition to using the cart to carry her goods, some shopping carts have designated seats for children, allowing the customer to travel with a small child, without requiring an additional stroller.

### BRIEF SUMMARY

One exemplary embodiment of the disclosed subject matter is a method performed in a shopping environment, wherein the shopping environment comprises a packaging zone and a shopping zone, wherein the shopping zone comprises a plurality of shelves in a plurality of aisles, wherein the shelves retain a multiplicity of identical copies of different items, wherein each different item is associated with an identifier, wherein each identical copy of the each different item is associated with the identifier, wherein a plurality of shared carts are located at different locations within the shopping zone, wherein the plurality of shared carts comprise a first cart and a second cart; the method comprises: marking, with a first sticker, a copy of a first item, wherein the copy of the first item is located on a shelf in a first aisle, wherein the first sticker identifies a customer; transferring the copy of the first item to the first cart, wherein the first cart is located at or near the first aisle, wherein the first cart comprises a plurality of marked items, at least one of which is marked with a sticker identifying another customer different than the customer; transferring items from the first cart to the packaging zone, whereby transferring the copy of the first item to the packaging zone; distributing the items from the first cart to packages for different customers, wherein said distributing is performed based on stickers affixed to the items, wherein said distributing comprises adding the copy of the first item to a package of the customer; marking, with a second sticker, a copy of a second item, wherein the copy of the second item is located on a shelf in a second aisle, wherein the second sticker identifies the first customer; transferring items from the second cart to the packaging zone, whereby transferring the copy of the second item to the packaging zone; distributing the items from the second cart to packages for different customers, wherein said distributing is performed based on stickers affixed to the items, wherein said distributing comprises adding the copy of the second item to the package of the customer, whereby incrementally preparing the package for the customer; and providing the package to the customer, whereby the costumer is provided with a set of purchased items without carrying together the set of purchased items while moving within the shopping zone.

Another exemplary embodiment of the disclosed subject matter is a method performed in a shopping environment, wherein the shopping environment comprises a packaging zone, a plurality of shared intermediate zones and a shopping zone, wherein the shopping zone comprises a plurality of shelves in a plurality of aisles, wherein the shelves retain a multiplicity of copies of different items, wherein each different item is associated with an identifier, wherein each identical copy of the each different item is marked with the identifier; the method comprises: marking a copy of an item, wherein said marking identifies the copy of the item as being associated with a customer; transferring the copy of the item to a shared intermediate zone, wherein the shared intermediate zone comprises a plurality of marked items, at least one of which is marked to be associated with another customer different than the customer; transferring items from the shared intermediate zone to the packaging zone, whereby transferring the copy of the item to the packaging zone; distributing the items from the shared intermediate zone to packages for different customers, wherein said distributing is performed based on the markings that identify customers associated with the items, wherein said distributing comprises adding the copy of the item to a package of the customer; and providing the package to the customer.

Optionally, said marking comprises affixing a sticker to the copy of the item, wherein the sticker uniquely identifies the costumer.

Optionally, said marking comprises digitally marking the copy of the item in a digital repository, wherein said marking is performed using at least one of a code scanner and a camera, to identify the copy of the item, wherein the copy of the item is identified using the identifier that is marked thereon.

Optionally, said marking comprises placing the copy of the item in an intermediate container that is associated with the customer, wherein the shared intermediate zone is configured in size and shape to store a plurality of intermediate containers.

Optionally, the shared intermediate zone is a shared cart.

Optionally, said transferring the items from the shared intermediate zone to the packaging zone comprises transferring the shared cart from a location in the shopping zone to the packaging zone.

Optionally, the method further comprises periodically transferring loaded shared carts from the shopping zone to the packaging zone, unloading the shared shopping cars in the packaging zone and transferring unloaded shared carts from the packaging zone to the shopping zone.

Optionally, the shared intermediate zone is a conveyor belt.

Optionally, said transferring the copy of the item to the shared intermediate zone is performed by a robotic arm that is configured to pick up the copy of the item from a shelf and transfer the copy of the item to the shared intermediate zone.

Optionally, said providing comprises: providing the package to the customer within the shopping environment, wherein said providing is performed in response to a payment of a bill by the customer, wherein the bill is generated automatically.

Optionally, said providing comprises: delivering the package to an external address of the customer, wherein the package comprises copies of items selected by the customer while the customer is physically located in the shopping zone.

Optionally, the plurality of aisles comprise at least one aisle that has an aisle spacing that is no more than 120 centimeters.

Yet another exemplary embodiment of the disclosed subject matter is a method performed in a shopping environment, wherein the shopping environment comprises a packaging zone, a plurality of shared intermediate containers and a shopping zone, wherein the shopping zone comprises a plurality of shelves in a plurality of aisles, wherein the shelves retain a multiplicity of copies of different items, wherein each different item is associated with an identifier, wherein for at least a portion of the each different item, each identical copy thereof is marked with the identifier; the method comprises: transferring a first shared intermediate container from the shopping zone to the packaging zone, wherein the first shared intermediate container comprises at least a first copy of a first item and a second copy of the first item, wherein the first copy of the first item is associated, using a marking, with a first customer, wherein the second copy of the first item is associated, using a marking, with a second customer; unloading the first shared intermediate container into packages, wherein said unloading comprises identifying an associated customer for each item in the first shared intermediate container, wherein said unloading comprises placing each item in a package associated with the associated customer, wherein based on said identifying the associated customer, updating a list of purchased items of the associated customer to include the each item, whereby placing the first copy of the first item in a first package that is associated with the first customer and updating a first list of purchased items of the first customer to include the first item, whereby placing the second copy of the first item in a second package that is associated with the second customer and updating a second list of purchased items of the second customer to include the first item; transferring a second shared intermediate container from the shopping zone to the packaging zone, wherein the second shared intermediate container comprises at least a copy of a second item, wherein the copy of the second item is associated, using a marking, with the first customer; unloading the second shared intermediate container into packages, wherein said unloading comprises identifying an associated customer for each item in the second shared intermediate container, wherein said unloading comprises placing each item in a package associated with the associated customer, wherein based on said identifying the associated customer, updating a list purchased items of the associated customer to include the each item, whereby placing the copy of the second item in the first package and updating the first shopping list to include the second item; transferring a third shared intermediate container from the shopping zone to the packaging zone, wherein the third shared intermediate container comprises at least a copy of a third item, wherein the copy of the third item is associated, using a marking, with the second customer; unloading the third shared intermediate container into packages, wherein said unloading comprises identifying an associated customer for each item in the third shared intermediate container, wherein said unloading comprises placing each item in a package associated with the associated customer, wherein based on said identifying the associated customer, updating a list of purchased items of the associated customer to include the each item, whereby placing the copy of the third item in the second package and updating the second list of purchased items to include the third item; receiving payment from the first customer based on the first list of purchased items; providing the first package to the first customer; receiving payment from the second customer based on the second list of purchased items; and providing the second package to the second customer.

Yet another exemplary embodiment of the disclosed subject matter is a system comprising: a shopping zone, wherein the shopping zone comprises a multiplicity of identical copies of different items, wherein each different item is associated with an identifier, wherein for at least a portion of the different items, each identical copy of each different item in the portion is marked with the identifier; a marking means for enabling a customer to mark a copy of an item in the shopping zone to associate the marked copy with the customer; a plurality of shared intermediate zones spread across the shopping zone, wherein each shared intermediate zone is configured to temporarily retain a plurality of marked copies of different customers at the same time, wherein a plurality of marked copies associated with the customer are distributed in two or more shared intermediate zones; and a packaging zone comprising a package associated with the customer, wherein the plurality of marked copies are added into the package after being transferred from the plurality of shared intermediate zones to the packaging zone.

Optionally, the plurality of shared intermediate zones comprise a plurality of shared carts.

Optionally, the system further comprises a scanning means for scanning a marked copy of an item to retrieve an associated customer thereof, wherein said scanning means is operatively coupled to a billing system that is configured to update a list of purchased items of the associated customer.

Optionally, the system further comprises a plurality of robotic devices for transferring marked copies of items from the shopping zone to the plurality of shared intermediate zones.

Optionally, the system is absent of shopping carts that are uniquely associated with a specific customer during a shopping session.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a shopping zone within a shopping environment, in accordance with some exemplary embodiments of the disclosed subject matter.

FIGS. 2-4 show flowchart diagrams of methods, in accordance with some exemplary embodiments of the disclosed subject matter; and

FIG. 5 shows a block diagram of an apparatus, in accordance with some exemplary embodiments of the disclosed subject matter.

### DETAILED DESCRIPTION

In some exemplary embodiments, a shopping environment such as a supermarket, may comprise a shopping zone. The shopping zone may comprise aisles. The aisles may comprise shelves, each of which may be adapted to hold, retain, or the like, a multiplicity of identical copies of different items. Customers may move in the shopping zone, between the aisles and collect items. An item may by a product, such as a loaf of regular bread, Coca Cola™ 1.5 liter bottle, Coca Cola™ 1 liter bottle, a TRIX™ cereals, a tomato, a milk carton of 3% fat, 1 liter volume, a milk carton of 1% fat, 2 liter volume, or the like. The multiplicity of items in the shopping zone may comprise a plurality of products of the same kind that are available in the shopping zone. It is noted that there may be several copies of the same item. A copy of an item may refer to an instance of product. As an example, a copy of an item may refer to a specific bottle of Coca Cola™ 1 liter bottle that may be collected and purchased by a customer. In some exemplary embodiments, each different item may be associated with an identifier. As an example, all the bottles of Coca Cola™ of the same size may have an identical barcode affixed thereto, so as to allow barcode readers to identify the item, using each different copy. Additionally or alternatively, an unpacked bread product may be associated with an identifier that may or may not be affixed thereto. The identifier may be utilized by a cashier to identify the product and its price, when preparing a bill. Each different copy of the unpacked bread product may be associated with the same identifier, representing the product rather than the instance.

One technical problem dealt with by the disclosed subject matter is to providing a shopping environment in which the customer need not carry, by hand, by using a cart or by other similar means, the entire collected goods with him during the shopping session. In some cases, it may be desired to free the customer to walk freely in the shopping zone and enjoy the shopping experience. In some cases, a means for transferring items, copies, or the like, from shelves to a packaging zone may be desired. In some exemplary embodiments, it may be desired to offer a means for transferring marked copies from shelves to the packaging zone without the customer need to carry the marked items to the packaging zone during the shopping session. It is further desired to provide for a means that would allow the customer to personally select the copies that she would like to purchase from the shelves, on the one hand, and on the other to free him from the need to personally carry the copies from the shelves to a checkout location.

Another technical problem dealt with by the disclosed subject matter is to offer a method that will allow a better exploitation of the space of the shopping zone. The shopping zone may comprise personal carts, non-sharable carts, or the like, that may require space. It may be desired to reduce the space taken by the carts in order to increase the number of concurrent customers in the shopping zone, without overcrowding the aisles. In some cases, it may be desired to improve space utilization within the shopping zone, such as to increase the number of copies of items retained therein, increase the number of shelves, increase the number aisles, or the like.

Yet another technical problem dealt with by the disclosed subject matter is to offer a means for marking goods, copies of identical items, or the like, in a shopping environment. In some exemplary embodiments, packaging and billing may be performed without the customer presence, and based on copies of items that are marked by the customer. It may be desired to offer a means for the customer to mark her copies in order to ensure that the copies that she collected are provided to her, upon picking up her package. Additionally or alternatively, it may desired to ensure that the bill issued to her is based on the copies that she purchased.

One technical solution is to provide a plurality of shared intermediate zones within the shopping zone. In some exemplary embodiments, a shared intermediate zone may be in use, simultaneously, between customers for retaining portions of the customers' shopped copies. In some exemplary embodiments, the shared intermediate zones may be located at different locations in the shopping zone. In some exemplary embodiments, the different locations may be different aisles, junctions of aisles, near an elevator, near a bakery that is located inside the shopping zone, or the like. A customer may mark a copy of an item and transfer the marked copy to a shared intermediate zone. The shared intermediate zone may comprise marked items that were marked by different customers. Periodically, copies that are contained in the shared intermediate zone may be transferred to a packaging zone. At the packaging zone, copies from different shared intermediate zones, marked by different customers, may be distributed to packages, each of which may be associated with a different customer. While packaging, per each customer, a list of purchased copies may be produced. In some exemplary embodiments, each time copies from a different shared intermediate zone are sorted and added to the package of the customer, the list may be updated. Additionally or alternatively, the list may be updated incrementally, when the copies are processed, manually or automatically by an entity different than the customer, rather than being generated at the end. In some exemplary embodiments, each time that the list is updated, a bill may be updated as well. The bill may comprise a sum of prices of copies comprised by the list of purchased items.

In some exemplary embodiments, a shared intermediate zone may be a shared cart. A shared cart may be a supermarket cart, a cart that is larger than the usual supermarket cart, a wheeled container, or the like. The shared cart may retain, simultaneously, copies of identical items, marked by different customers. The different customers may share the shared cart during their shopping sessions. In some exemplary embodiments, customers may not carry, move, or the like, the shared cart. As an example, a customer may not carry the shared cart to a checkout zone, where payment is made. In some exemplary embodiments, the shared cart may be moved by employees of the shopping environment, automatically using drones or autonomously, or the like.

In some exemplary embodiments, a shared intermediate zone may be a conveyor belt. A conveyor belt may be placed a long an aisle. Customers may mark a copy and place the copy on the conveyor belt. The conveyor belt may be configured to transfer the copies to a packaging zone. The conveyor belt may be configured to operate continuously. Additionally or alternatively, in order to reduce energy consumption, the conveyor belt may be configured to commence operating when a copy is placed thereon. The conveyor belt may continue operating until the copy is transferred elsewhere, such as to another conveyor belt, to the packaging zones, or the like. In response to the conveyor belt becoming vacant, the conveyor belt may stop its operation. In some exemplary embodiments, determining when an area is packed may be performed automatically by utilizing a camera and computer vision algorithms, by determining the weight of copies that are placed on the belt using weight sensors, or the like.

In some exemplary embodiments, the shared intermediate zones may be shared containers. The shared containers may be stationary, devoid of wheels, or the like. In some exemplary embodiments, the content of the shared containers may be transferred to the packaging zone using a transferring device, such as a forklift. Additionally or alternatively, the content of the shared containers may be transferred without moving the shared containers, such as by emptying the content of the shared containers into another moveable container, or the like.

In some exemplary embodiments, the content of the shared intermediate zone may be transferred to the packaging zone periodically, such as every 5 minutes, every 10 minutes, or the like. Additionally or alternatively, the content of the shared intermediate zone may be transferred to the packaging zone in case that the shared intermediate zone is about to get full, such as by reaching 70% capacity, 90% capacity, or the like. In some exemplary embodiments, sensors may be mounted on the shared intermediate zone or directed thereto, so as to determine when a shared intermediate zone requires evacuation.

In some exemplary embodiments, the shared intermediate zone may be configured in size and shape to hold a plurality of intermediate containers. An intermediate containers may a personal shopping basket. Each costumer may place copies at her own intermediate container. Once the intermediate container is full, about to get full, or the like, the customer may place her intermediate container at a shared intermediate zone, collect an empty intermediate container and resume her shopping. Additionally or alternatively, a customer may place his intermediate container, even if the intermediate container is not full, when she leaves an aisle or another portion of the shipping zone and heading to another location. As an example, a customer may reach the snacks area and take an intermediate container located in her vicinity. The customer may then collect copies of snacks into the intermediate container, place the intermediate container at the shared intermediate zone. When the customer reaches a different area, such as the fruit and vegetable area, she may take another intermediate container and use that container to place selected fruits and vegetables. Once finished, the customer may place the second intermediate container in a second shared intermediate zone. It is noted that when the customer takes an intermediate container, she may mark the container as associated to her, such as using a sticker, a barcode scanner, using digital registration, or the like. In some exemplary embodiments, the intermediate containers may be configured in size, weight and shape to be carried by customers, such as a hand bag, a shopping basket, or the like. Additionally or alternatively, the intermediate containers may be configured in size, weight and shape to be placed within the shared intermediate zones, such as without occupying a substantial portion thereof. For example, the size and shape of both the intermediate containers and the shared intermediate zones may be configured to allow placing of over ten, twenty, or the like intermediate containers within a single shared intermediate zone. In some exemplary embodiments, when placed within the shared intermediate zone, the intermediate containers may be placed with no gaps between them. Additionally or alternatively, a railing or another form of guiding mechanism may be incorporated within the shared intermediate zones so as to guide placement of the intermediate containers, such as to provide for optimal placement.

Another technical solution is to offer a means for marking items collected by the customer. In some exemplary embodiments, the means for marking may be personal stickers, an application, a personal/intermediate container, or the like.

In some exemplary embodiments, stickers that identify the customer may be provided thereto. The customer may collect the stickers upon arriving to the shopping zone. Additionally or alternatively, the stickers may be provided to the customer in a place of her choosing. In some exemplary embodiments, the customer may affix, attached, or the like, a sticker to a copy she wishes to purchase. The customer may transfer the marked copy to a shared intermediate zone. The content of the shared intermediate zone may be transferred to the packaging zone. At the packaging zone, the content may be distributed, based on the stickers, to personal packages for customers. In some exemplary embodiments, the stickers may comprise a barcode, Quick Response (QR) code, or the like, identifying the customer. The stickers may be scanned using an electronic scanner which

In some exemplary embodiments, customers may be provided with an application as a means for marking copies. In some exemplary embodiments, a customer may download to her mobile device an application. Using the application, the customer may digitally mark a copy of an item as part of her purchased items. In some exemplary embodiments, the digital marking may be retained in a digital storage, such as in an edge server, a remote cloud server, local storage, or the like. In some exemplary embodiments, using the application, the customer may scan or take a photo of a copy to be purchased. In some exemplary embodiments, each copy may be marked with a unique copy identifier in addition to or instead of the item identifier. Additionally or alternatively, using computer vision, the product may be uniquely identified. In some exemplary embodiments, marking using an application may be approximated such as the system may be notified that the customer marked a copy of a specific item based on the item identifier. In the packaging zone, a copy that matches the marked item identifier may be distributed into the package of the customer. In some exemplary embodiments, distribution may be performed on a First-In-First-Out (FIFO) order generally. Additionally or alternatively, the distribution may be performed on a FIFO order within a specific shared intermediate zone. For example, based on a location of the customer when marking a copy, a near-by shared intermediate zone may be identified and the respective copy of the customer may be considered as being added to the identified near-by shared intermediate zone.

In some exemplary embodiments, a personal intermediate container may be provided as a means for marking copies of items. A customer may scan the personal container, affix a personal sticker to the personal container, or the like. By placing a copy in the personal container, the placed copy may be considered as marked, similarly to the case where the customer affixed a personal sticker to the copy itself or scanned the copy itself. When the content of the shared intermediate zone is transferred to the packaging zone, the personal intermediate containers may be transferred, as is, to the packaging zone. At the packaging zone, the content of the shared intermediate zone may be distributed to personal package. Distribution of the content may comprise obtaining each personal intermediate container and transferring the container or the content thereof to a personal package.

In some exemplary embodiments, personal intermediate containers may be utilized to mark a group of items together. Additionally or alternatively, the personal intermediate containers may be useful for marking items that do not have barcodes affixed thereto.

One technical effect of utilizing the disclosed subject matter is to improve space utilization of a shopping environment. An average supermarket cart (in the USA) may be about 50 centimeters in width and about 80 centimeters in length. An average person (in the USA) may require about 100 square meters in order to have a reasonable shopping experience. Eliminating the use of regular carts, carts that may not be simultaneously shared, may allow to increase the number of concurrent shoppers by about 40%.

Another technical effect of utilizing the disclosed subject matter is a manner of associating a physical item (e.g., a copy of an item) with a customer in a reliable manner. The association may be preserved without the presence of the customer, allowing the store or other owner of the shopping environment to correctly sort different items to packages that are associated with the customers. In some cases, the association is implemented using the means for marking that are employed by the customers. A customer may mark a copy that she has purchased, that she wishes to purchase, or the like. The mark may uniquely identify her even if the copy is packed in a packaging zone without her presences, packed without human intervention, or the like.

Yet another technical effect of utilizing the disclosed subject matter is to enable a customer to do her shopping without carrying all the shopped items through the entire shopping session. Additionally or alternatively, the customer may not need to push or otherwise move a cart full of her entire shopped groceries. Instead, she may mark copies and have a hands-free experience. Additionally or alternatively, she may use an intermediate container and may carry a small portion of copies simultaneously, such as 5 copies at a time, 10 copies at a time, or the like.

Yet another technical effect may be providing an improved shopping experience to the customers. Avoiding the need to carry the entire shopped items simultaneously, by hands or using a cart, may free her hands. This may allow a customer who is doing her shopping with an infant, to continue using the infant's stroller, without transferring him to the cart. Additionally or alternatively, a handicapped patron may be enabled to do his shopping with relative ease, as he need not push a shopping cart throughout the shopping session. Additionally or alternatively, when a customer is dragging with a shopping cart, she may be limited in her ability to perform additional actions, such as use her mobile phone throughout the shopping session.

Yet another technical effect of utilizing the disclosed subject matter is to reduce the costs and resources required when providing customers with regular carts. Providing customers with regular carts may require monetary expenditure in purchasing the carts and due to their wear and tear, but also require collecting the unused carts from the shopping environment or the nearby parking lot, allocating space for ready-to-use carts to be picked up by the customers, or the like.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

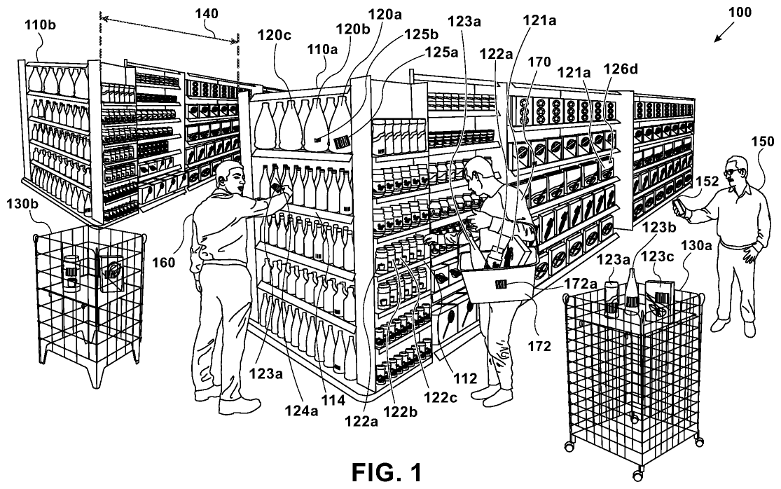

Referring now to FIG. 1, showing a shopping zone within a shopping environment, in accordance with some exemplary embodiments of the disclosed subject matter.

In some exemplary embodiments, a Shopping Zone 100 may comprise Shelving Units 110a, 110b. In some exemplary embodiments, an Aisle Spacing 140, may be the width of an Aisle between Shelving Unit 110a and Shelving Unit 110b. Aisle Spacing 140 may be smaller than the average width of aisles as there is no need for personal carts being carried therein. In some exemplary embodiments, Aisle Spacing 140 may be no more than 120 centimeters, allowing two people to move in opposite directions, but not necessarily allowing two carts to move in opposite directions. Additionally or alternatively, Aisle Spacing 140 may be smaller, such as about 80 centimeters, which would allow one customer to bypass another customer, when both customers are not using carts.

In some exemplary embodiments, Shelving Unit 110a may comprise a Shelves 112, 114, each of which may be used to place products offer for sale. As an example, Shelf 112 may retain different physical objects, such as, for example, different copies of the same item. Copies 122a, 122b, 122c may be copies of a specific, identical item, such as a 710 milliliter Barilla Pasta Sauce, Tomato and Basil™. As another example, Copies 120a, 120b, 120c may illustrate copies of another product, such as a 1 gallon GREAT VALUE ORIGINAL 100% ORANGE JUICE™, that are placed on another shelf, Shelf 114, within Shelving Unit 110a.

In some exemplary embodiments, copies of items may be selected from the shelves and marked to be associated with a specific customer who would like to purchase the selected copies. In some exemplary embodiments, the selected copies are marked using a marking means.

In some exemplary embodiments, the marking means may be a sticker. As an example, Customer 160 may select a product from Shopping Zone 100, such as Copy 123a, and affix a Sticker 124a, thereto. Sticker 124a may identify, such as using a barcode, a string, a unique identifier, a QR code, or the like, Customer 160. In some exemplary embodiments, Sticker 124a may be a passive or active transmitter, such as without limitation a beacon, a Radio-frequency identification (RFID) chip, or the like, that is configured to provide an identification of the customer.

Copy 120a may have a Sticker 125a affixed thereto. Additionally or alternatively, Copy 120b may have a Sticker 125b affixed thereto. Sticker 125a may have been placed on Copy 120a by Customer 160 in order to mark Copy 120a. Additionally or alternatively, Sticker 125b may have been placed by another customer (e.g., Customer 150). Accordingly, each sticker out of Stickers 125a, 125b may identify a different customer.

In some exemplary embodiments, an employee of a supermarket comprising Shopping Zone 100 may affix Stickers 124a and 125a in order to mark copies comprising a shopping list of customers while the customers are not present in Shopping Environment 100, while the customers are at a different zone of Shopping Environment 100, or the like.

In some exemplary embodiments, a Customer 150 may use a Smartphone 152 as a marking means. Smartphone 152 may have an application installed thereon that is used to digitally mark copies. Assuming Costumer 150 would like to mark Copy 126a, Customer 150 may use Smartphone 152 in order to scan a Barcode 126d. Smartphone 152 may comprise a barcode scanner, a camera, or the like. It is noted that other technologies, such as passive or active transmitters may be used. For example, each copy may be affixed with an RFID transmitter, and Smartphone 152 may utilize an RFID scanner. Once a copy is scanned, a digital registration is performed in a database, adding the copy to the list of purchased items of the relevant customer, and the copy may be deemed as “digitally marked”.

It is noted that in some exemplary embodiments, each copy may have a unique barcode, such as differentiating between different copies of a same item. As a result, the digital marking means identifies a specific copy as being associated with Customer 150.

Additionally, or alternatively, each copy may have an item barcode that is identical to all copies of the same item. In such a case, the marking means marks a general copy of the item and not necessarily the specific item that the customer had picked. In some cases, during distribution of collected copies, one copy of the type that Customer 150 had marked may be provided added to the package of Customer 150. In some cases, in if there are several copies of the same item marked for different customers, they may be distributed in accordance with a First-In First-Out (FIFO) order.

in some exemplary embodiments, a marked copy may be physically moved to a shared intermediate zone, such as Shared Cart 130a. In some exemplary embodiments, the customer who marked the copy may pick up the copy and place it in Shared Cart 130a. Additionally, or alternatively, an employee of the supermarket may periodically scout the shelving units and move marked items. Additionally, or alternatively, robotic devices may be utilized for automatically picking up marked items, removing them from the shelves and placing them in shared carts or other shared intermediate zones.

In some exemplary embodiments, intermediate containers may be utilized as marking means. A Customer 170 may use an Intermediate Container 172. Customer 170 may collect copies, such as Copies 121a, 121b, 121c, and place them in Intermediate Container 172. Customer 170 may place Copies 121a, 121b, 121c in Intermediate Container 172 in order to purchase Copies 121a, 121b, 121c. By placing Copies 121a, 121b, 121c in Intermediate Container 172, Customer 170 may mark such copies. As is illustrated in the figure, Copies 121a, 121b, 121c are not marked using a sticker, and they may also not be digitally marked. Instead, Intermediate Container 172 may be associated with Customer 170 and any copy located therein may be considered as being marked due to them being comprised therein. Customer 170 may place Intermediate Container 172 within Shared Cart 130a, and continue shopping without having to carry the selected items. In some exemplary embodiments, Intermediate Container 172 is marked as being associated to Customer 170 using another marking means. For example, Barcode 172a may be a sticker that was placed on Intermediate Container 172 in order to mark Intermediate Container 172 as being associated with Customer 170. Additionally, or alternatively, Barcode 172a may be a permanent barcode located on Intermediate Container 172. Using a scanning device, such as Smartphone 152, Customer 170 may scan Barcode 172a to associate this specific intermediate container with him for the duration of his shopping session.

It is further noted that in some embodiments, Intermediate Container 172 may be a container that can be sealed, or otherwise closed, so as to ensure that products that were placed within Intermediate Container 172 would not fall off it, unintentionally, when the Intermediate Container 172 is placed on the Shared Cart 130a.

In some exemplary embodiments, Shopping Zone 100 may comprise shared intermediate zones such as Shared Cart 130a, Shared Container 130b, or the like. Shared intermediate zones may be shared by customers in order to place marked items therein. In some exemplary embodiments, at least two customers may simultaneously use a shared intermediate zone. Hence, the shared intermediate zone may retain copies (e.g., of the same item or of different items) that are marked as being associated with different customers that are in the midst of their shopping session. Additionally, or alternatively, the selected items to be purchased of a single customer may be divided and placed simultaneously and during the shopping session, in different carts, containers, or the like.

In some exemplary embodiments, shared intermediate zones may be carts, containers, or the like. For example, Shared Cart 130a may be a shared intermediate zone. Shared Cart 130a may be evacuated and pushed away it is desired to empty its content. In some exemplary embodiments, Shared Cart 130a may be moved using its wheels and transferred to a packaging zone. Additionally, or alternatively, Shared Container 130b, which may be stationary and may have no wheels, may be a shared intermediate zones. In some exemplary embodiments, the content of Shared Container 130b may be emptied while located in Shopping Zone 100. Additionally, or alternatively, Shared Container 130b itself may be transferred to another location for processing. In some exemplary embodiments, a forklift may be used to pick up and move Shared Container 130b. In some exemplary embodiments, where a shared intermediate zone is transferred to the packaging zone itself, another intermediate zone may be brought in to replace it. For example, another cart would be wheeled in to take the place of Shared Cart 130a if Shared Cart 130a is evacuated.

In some exemplary embodiments, Shared Cart 130a may comprise a Copies 123a, 123b, 123c. Copy 123a may have been marked by Costumer 150 while Copies 123b and Copy 123c may have been marked by Costumer 170. In some exemplary embodiments, Shared Cart 130a may comprise more copies marked by other customers (not shown).

Additionally or alternatively, Customer 170 may move from Shelving Unit 110a, place Intermediate Container 172 in Shared Intermediate Zone 130a and mark items that are at Shelving Unit 110b. Additionally or alternatively, while Customer 170 is marking items at Shelving Unit 110a, Customer 150 may move to Shelving Unit 110b, pick an intermediate container (not shown), and place copies in the intermediate container. Additionally or alternatively, Customer 160 may mark items at Shelving Unit 110a.

In some exemplary embodiments, Shared Cart 130a may be wheeled to a packaging zone. Copies comprised by Shared Cart 130a may be unloaded, scanned and distributed to packages. Additionally or alternatively, the content of Shared Container 130b may be transferred to the packaging zone. In both cases, the marked copies may be transferred to the packaging zone (not shown).

At the packaging zone, a portion of the copies may be packed to a first package associated with Customer 150. The first package may comprise copies marked by Customer 150. Additionally or alternatively, another portion of the copies may be distributed from Shared Cart 130a and from Shared Container 130b. The copies may be packed to a second package associated with Customer 160. Another portion of the copies may packed to a third package associated with Customer 170. In some exemplary embodiments, each customer may pay his bill and each package may be released and provided to the associated customer. In some exemplary embodiments, the package may be provided to the customer at the store, at the parking lot, delivered to his home, or the like.

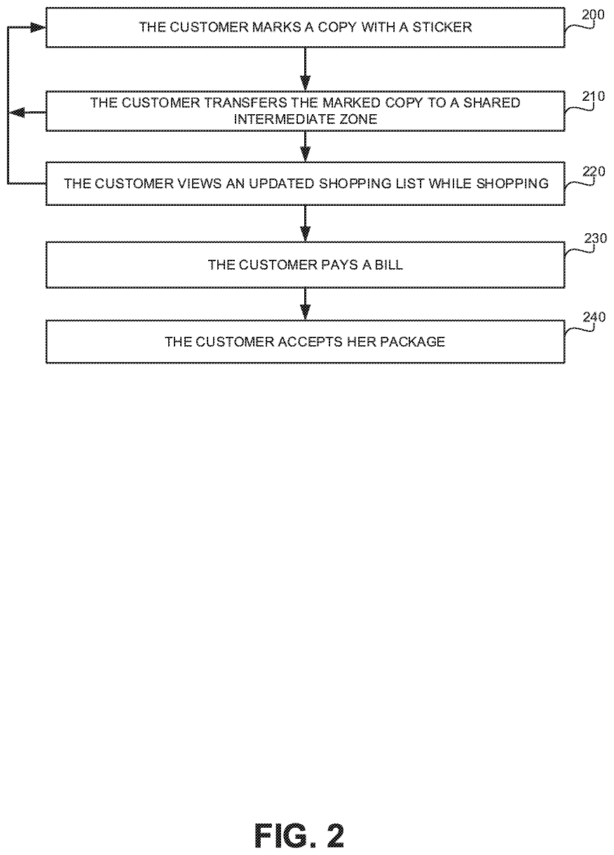

Referring now to FIG. 2, showing a flowchart diagram of a method, in accordance with some exemplary embodiments of the disclosed subject matter.

On Step 200, a customer may mark a copy with a sticker. The copy may be an identical copy of a plurality of copies of an item. As an example, the item may be a half a liter bottle of orange juice made by Florida's Natural™. There may be a multiplicity of identical copies of bottles of orange juice placed on the shelves, and the customer may pick one by marking it with the sticker. The sticker may uniquely identify the customer.

As an example, the customer may affix Sticker 125a of FIG. 1 on Copy 120a. As is illustrated in FIG. 1, the sticker may be placed manually, and therefore may be crooked.

In some exemplary embodiments, affixing a sticker to the copy may ensure that the copy may be associated with the customer during packaging. Additionally or alternatively, affixing a sticker may ensure that the copy may be associated with the costumer during billing. Additionally or alternatively, affixing a sticker may ensure that other customers may not purchase the copy, and it may be considered as already “reserved” or “purchased” by the customer.

In some exemplary embodiments, a customer may attach a sticker to a bag, or another container, holding a group of copies. As an example, a client may put cucumbers into a bag and may attached one of her personal stickers to the bag, indicating that the cucumbers therein are to be purchased by her. In some exemplary embodiments, the sticker on the bag may be a similar to the sticker used for pre-packaged items. Additionally or alternatively, stickers used for bulk goods, such as vegetables, fruits and roasted seeds, may be printed after the bag is weighed and may comprise, in addition to the customer identifier, weight of the bag, cost of the products, or the like.

In some exemplary embodiments, another means for marking, other than a sticker may be provided to customers. In some exemplary embodiments, a code, such as a bar code, a QR code, RFID, or the like, may be associated with a copy. The code may uniquely identify a single copy. Customers may scan a copy in order to mark it. In case that a customer marked a copy, another costumer may not be able to mark that copy of the item.

In some exemplary embodiments, the means for marking a copy may be provided to a customer by providing to the customer with an intermediate container. By placing a copy in the intermediate container, the copy may be considered as marked by the customer. An intermediate container may be personal in the sense that it is not simultaneously shared between customers. In some exemplary embodiments, a customer may be provided with stickers and affix the stickers to intermediate containers in order to associate the intermediate container with her. As a result, copies that are in the intermediate container may be associated with her. Additionally or alternatively, the association between the customer and the intermediate container may be based on a digital recordation of the association, such as using a mobile app to scan an identifier of the intermediate container, instead of the usage of personal stickers. It is noted that the intermediate containers may be readily available in the shopping zone, to be picked up by a customer when needed, and not necessarily in the beginning of her shopping session.

On Step 210, the customer may transfer the marked copy to a shared intermediate zone. In some exemplary embodiments, the customer may transfer copy by copy to the shared intermediate zone. Additionally or alternatively, the customer may collect a number of copies and transfer them simultaneously to the shared intermediate zone. In some exemplary embodiments, the customer may place the copies she marked in a shared cart that is located nearby. The shared cart may be placed, for example, in the same aisle as the copies that were purchased, or in proximity thereof. In some cases, there may be a shared cart within several meters from any location in the shopping zone, so as to avoid having the customer walk a long distance with many products in her hands. As an example, the maximal walking distance may be about 10 meters, 20 meters, 30 meters, or the like.

In some exemplary embodiments, a copy of an item may be transferred to an intermediate zone by a robotic arm. The robotic arm may be configured to pick up the copy and transfer it to shared intermediate zone. As an example, the robotic arm may be operationally coupled with a camera. The camera may be used to detect that a customer affixed a sticker on a copy. In response to such detection, the robotic arm may be invoked to pick up the marked copy and place it in a shared intermediate zone. In one embodiment, the robotic arm may be invoked to perform a batch operation after several copies are marked by the same customer or by different customers. In some exemplary embodiments, the shared intermediate zone may be a nearby conveyor belt. Additionally or alternatively, the shared intermediate zone may be a shared cart. In some exemplary embodiments, the shared cart may be autonomous and may comprise the robotic arm. The shared cart may travel to the shelf retaining the marked copy and pick such copy.

On Step 220, the customer may view an updated list of purchased items while shopping. The list may be updated each time that the customer marks a copy, reducing the risk that the client may mark another copy of the same product without needing the another copy. Additionally or alternatively, the list may be updated when the marked copies are scanned for packaging purposes, such as may be the case when the marking is performed in a non-digital manner. In some exemplary embodiments, updating the list may comprise updating entries in the customer's shopping list. As an example, the customer's shopping list may comprise a “Water Melon” entry. The customer may mark a copy of a water melon by using a sticker, an application, or the like and the shopping list of the costumer may be updated by displaying a “V” sign next to the water melon entry, by striking through the water melon entry, or the like. Additionally or alternatively, a list of purchased items may be updated and show “Water Melon”. In some exemplary embodiments, the list of purchased items may comprise the price of each marked item. Additionally or alternatively, the list of purchased items may comprise the total sum of prices of copies that are currently marked by the customer.

In some exemplary embodiments, in case that the total price of marked copies is more than the customer has planned to spend or if she changed her mind for any other reason, she may unmark a copy. In case that the means for marking is a sticker, the customer may remove the sticker from the copy. Additionally or alternatively, in case that the means for marking is an application allowing the customer to scan a code, take a photo of an item, or the like, the customer may rescan the item or take another picture of the item in order to unmark it. Additionally or alternatively, in case that the means for marking is a personal intermediate container, the customer may place back the item that is in the personal intermediate container. In some exemplary embodiments, a customer may mark a copy and transfer the copy to a shared intermediate zone. In order to unmark a copy the customer may delete the entry of the copy from the list of purchased items, and the return of the unmarked copy to the shelf from the packaging zone may be implemented by the owner of the shopping environment, such as during shelf re-stocking.

On Step 230, the costumer may pay a bill. The bill may comprise prices of copies that customer marked. The bill may be paid automatically, such as using an application, a digital wallet, or the like. Additionally or alternatively, the customer may watch the bill in her application and approve the payment. In some exemplary embodiments, a payment device may be located at the vicinity of the exit of the shopping zone. Additionally or alternatively, a cashier, human or robotic, may be placed at the boundaries of the shopping zone. The customer may pay the bill as she leaves the shopping zone.

On Step 240, the customer may accepts a package. The customer may accepts the package as she leaves the shopping zone. Additionally or alternatively, the package may be delivered to an external address, external to the shopping zone, such as the customer's house, office, or the like. In some exemplary embodiments, the package may comprise copies marked by the customer, while the customer was physically present at the shopping zone. Additionally or alternatively, the package may comprise a subset of copies marked by the customer. As an example, the customer may mark an ice cream. She may rather take the ice cream with her instead of waiting for the package in order to prevent the ice cream from melting.

In some exemplary embodiments, the package may be prepared in a packaging zone. In some exemplary embodiments, copies that are transferred to shared intermediate zones (e.g., in Step 210) are later transferred to the packaging zone, to prepare personal packages for the customers based on the markings.

In some exemplary embodiments, Steps 200-220 may be repeated. The customer may mark an item, transfer it to a shared intermediate zone with respect to a plurality of different items or copies of items. The customer may intermittently view an updated list of purchased items.

In some exemplary embodiments, the costumer may mark the last copy that she wishes to purchase with a different marker. As an example, in case that the costumer is affixing stickers to items, each sticker may have a barcode that embeds the identification of the customer and an identification of a type of sticker. There may be “regular” stickers that are used during a shopping session and a “final” sticker that is used to indicate an end of a shopping session. Additionally or alternatively, in case that the marking means is an application, the application may comprise a “checkout” button, indicating that the shopping session is completed. Additionally or alternatively, the application may be used to mark a specific copy as the last item, such as using a “last item” button that can be pressed before or after the last item is scanned.

In some exemplary embodiments, copies may be scanned at the packaging zone. In case that the item that is marked as the last item, the package of the customer may be sealed after the last item is processed and added to the package of the customer. In some exemplary embodiments, the content of a shared intermediate zone may be transferred periodically to the packaging zone. In case that the last item is identified, a time period may be waited before sealing the package of the customer in order to ensure that there are no pending copies that the customer marked that have not yet been transferred to the packaging zone and processed. Additionally or alternatively, heuristics may be employed to await transfer of content of specific shared intermediate zones, such as zones that are located in proximity to the locations that the user was in during her shopping session, during a last time window of the shopping session, or the like. In some cases, the locations of the user may be identified using positioning means, such as triangulation of the receivers of the mobile phone used by the customer. In some exemplary embodiments, the positioning means may be indoor positioning means, outdoor positioning means, such as GPS, or the like. Additionally, or alternatively the locations may be approximated based on the locations of the shared intermediate zones that were used by the customer throughout her shopping session.

In some exemplary embodiments, after the last item indication is received the shopping session may be considered as completed. The customer's package may be sealed, and transferred for pickup by the customer, delivered to the customer, or the like. In some exemplary embodiments, in response to the identification of the end of the shopping session, the customer may be prompted to pay her bill. Additionally or alternatively, in response to the identification of the end of the shopping session, the package may be transferred to a pickup location, where the customer may pay her bill and pick up the package.

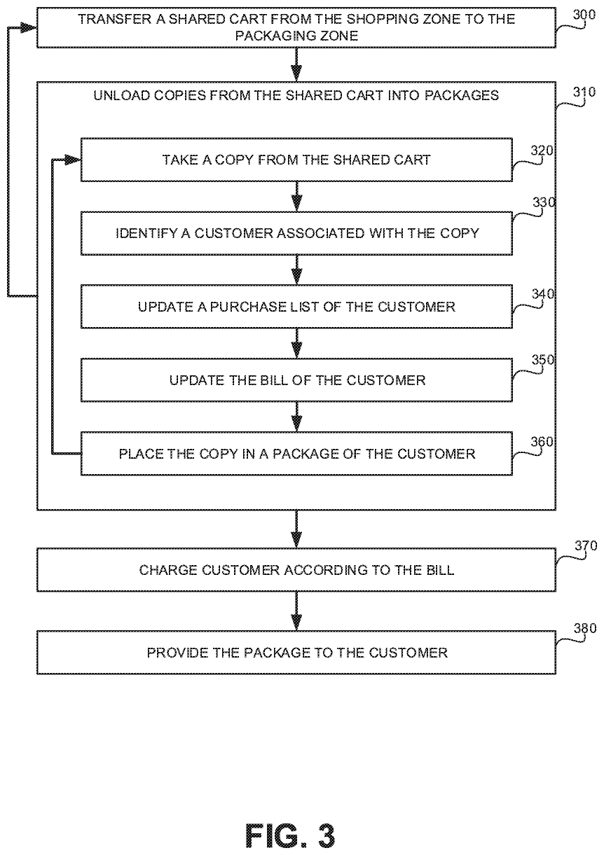

Referring now to FIG. 3, showing a flowchart diagram of a method, in accordance with some exemplary embodiments of the disclosed subject matter.

In some exemplary embodiments, a shared intermediate zone may be a shared cart, such as Shared Cart 130a of FIG. 1. On Step 300, the shared cart may be transferred from the shopping zone to the packaging zone, resulting in transferring copies from a location in the shopping zone to the packaging zone. The shared cart may be transferred periodically, such as every 10 minutes, every 20 minutes, or the like. Additionally or alternatively, the period time for transferring the shared cart may be set according to the load in the shopping zone. As an example, in case that there are many customers the time period may be every 2 minutes, every 5 minutes, or the like. Additionally or alternatively, in case that the load is below a threshold, the time period may be half an hour, an hour, or the like. Additionally or alternatively, in case that a first shared cart is used more often than a second shared cart the first shared cart may have one time period for being transferred to the packaging zone and a second shared cart may have a second time period for being transferred to the packaging zone. The first time period may be smaller the second time period.

In some exemplary embodiments, the content of the shared cart may be transferred without moving the shared cart itself. Additionally or alternatively, in case of a wheeless container, such as 130b of FIG. 1, a forklift may be used to transfer the container from one location to another.

On Step 310, copies from the shared cart may be unloaded and distributed into packages. Step 310 may comprise steps 320-350. Additionally or alternatively, unloaded shared carts may be transferred from the packaging zone back to locations in the shopping zone. Additionally or alternatively, upon transferring a shared cart from the shopping zone the packaging zone, an empty shared cart may be transferred, manually or automatically, from a storage zone to the shopping zone. An unloaded shared cart may be transferred from the packaging zone to storage zone.

On Step 320, a copy may be taken out from the shared cart. The copy may have been marked by a customer, physically, digitally, or the like.

On Step 330, a customer associated with the copy may be identified. In some exemplary embodiments, the copy may have been marked with a sticker that uniquely identifies the customer. In order to identify the customer that marked the item with the sticker, the sticker may be scanned by a scanner. The scanner may be operatively coupled with a database. The database may comprise identification number of stickers. Additionally or alternatively, the database may comprise means for identifying customers, such as identification number, images of the customers, or the like. Once the scanning is complete, the scanner may provide a unique identifier of the customer that marked the item.

Additionally or alternatively, the copy may be marked using an intermediate container. The identification of the customer for the intermediate container may be performed and all items within the intermediate container may be considered as marked with the same customer. In some exemplary embodiments, at the packaging zone, each item in the intermediate container may be scanned individually to be added to the purchase list (Step 340).

Additionally or alternatively, the copy may be marked in a digital manner, such as using an application. The digital marking may be manifested in a database. Upon scanning the copies, information from the database may be retrieved and displayed, such as information indicating the customer marking the copy. In some exemplary embodiments, the in case each copy is not uniquely identified, but rather has a same identifier uniquely identifying the item (e.g., an identifier of a COCA COLA™ 1.5 liter bottle appearing on each such bottle may be identical). Upon scanning the copy, a list of customers that marked a copy of the identified item may be retrieved. A first customer therefrom may be obtained and removed from the list, implementing a FIFO order. Additionally or alternatively, different ordering may be implemented. Customers identified as being on their way to complete their shopping session, such as based on track behavior thereof, may be given precedent and pushed up in queue.

In some exemplary embodiments, during the identification of the customer, a price tag may be added to the copy. In some exemplary embodiments, the copy may be priced based on the weight of the copy. As an example, the copy may be a vegetable, a fruit, or the like. Additionally or alternatively, the copy may be a group of vegetables or fruits of the same kind such as a bag comprising eggplants, a box comprising avocados, or the like. In such embodiments, the copy may be weighted by a human, by a robot, or the like. In some exemplary embodiments, the packaging zone may comprise a surface with weight sensor for automatically weighting copies.

On Step 340, a list of purchased items may be updated. The list may comprise items that the customer marked. Additionally or alternatively, the list may comprise prices of items comprised by the list. In some exemplary embodiments, the list may be available in real time to the customer via a browser, an application, or the like, such as described in relation to Step 220 of FIG. 2.

On Step 350, the price of the copy may be added to a bill. The bill may be updated incrementally as copies are being transferred to packaging zone and scanned therein.

On Step 360, the copy may be placed in a package. The package may be uniquely associated with the same customer that the copy is uniquely associated with.

Steps 320-360 may be performed repeatedly as long as there are copies in the shared cart. Upon compilation the shared cart may be returned to the shopping zone.

Steps 300 and 310 may be performed repeatedly as long as customers are transferring copies to the shared cart. In some exemplary embodiments, each time a shared cart that comprises at least one copy marked by the customer, Steps 300-310 may be re-performed.

On Step 370, the customer is charged according to the bill. The customer may be charged in a payment zone, in a checkout zone, or the like. Additionally or alternatively, the costumer may be charged using an application. Additionally or alternatively, the payment may be performed automatically.

On Step 380, the package may be provided to the customer. The package may comprise a set of purchased copies. In some exemplary embodiments, the customer did not needed to carry, neither by hand nor by a personal cart, all the purchased copies. Instead, the purchased copies may be provided to her at the end of shopping. In some exemplary embodiments, the package may be delivered to the customer to an external address.

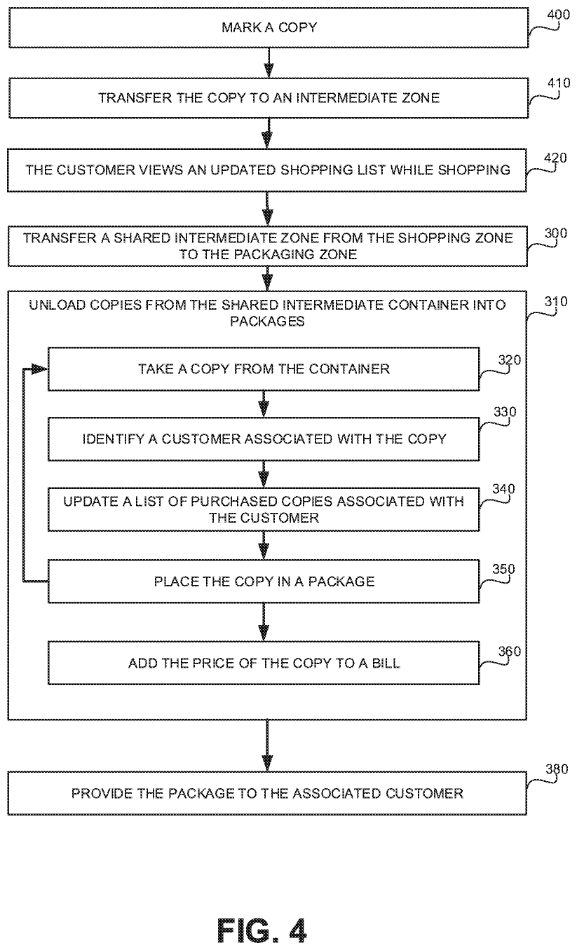

Referring now to FIG. 4, showing a flowchart diagram of a method, in accordance with some exemplary embodiments of the disclosed subject matter.

On Step 400, a copy is being marked. The copy may be marked by a customer as in Step 200 of FIG. 2. Additionally or alternatively, the copy may be marked by an employee of the shopping environment. Additionally or alternatively, the copy may be marked digitally by utilizing a computerized system. As an example, a client may use a browser, an application, or the like in order to prepare a shopping list. The shopping list may be transmitted to a computerized environment connected to the shopping zone and a robot may mark copies that comprised by the shopping list.

On Step 410, a marked copy may be transferred to a shared intermediate zone. The copy may be transferred by an employee of the shopping zone, by a robot, or the like. The copy may be transferred by the same entity that marked the copy. Additionally or alternatively, the copy may be transferred by another entity, such as by another employee, another robot, or the like.

In some exemplary embodiments, in case that the marking means is a personal intermediate container, Step 400 may be performed by placing an item in the personal intermediate container. Additionally or alternatively, Step 410 may be performed by placing the personal intermediate container in the shared intermediate zone.

In some exemplary embodiments, the shared intermediate zone may be configured in size and shape to store a maximal number of personal intermediate containers. As an example, a personal intermediate container may have the dimensions of 20 cm length, 10 cm width and 15 cm height. The shared intermediate zone may have dimensions that are a multiplication of the dimensions of the intermediate container by natural numbers, such as by a factor of 5, factor of 8, factor of 10, or the like. For example, the dimensions of the shared intermediate zone may be 100 cn in length, 80 cm in width, and 150 cm in height. In some exemplary embodiments, there may be rails or guides to place the intermediate containers within the shared intermediate zone so as to maximize utilization of space therein.

Step 420 may be performed similarly to Step 220 of FIG. 2. In some exemplary embodiments, the customer may view updates of the list of purchased items while steps 400 and 410 are performed. In some exemplary embodiments, the customer may see the progress of his shopping even if she is not present at the shopping zone, such as when a proxy is implementing the shopping session on her behalf.

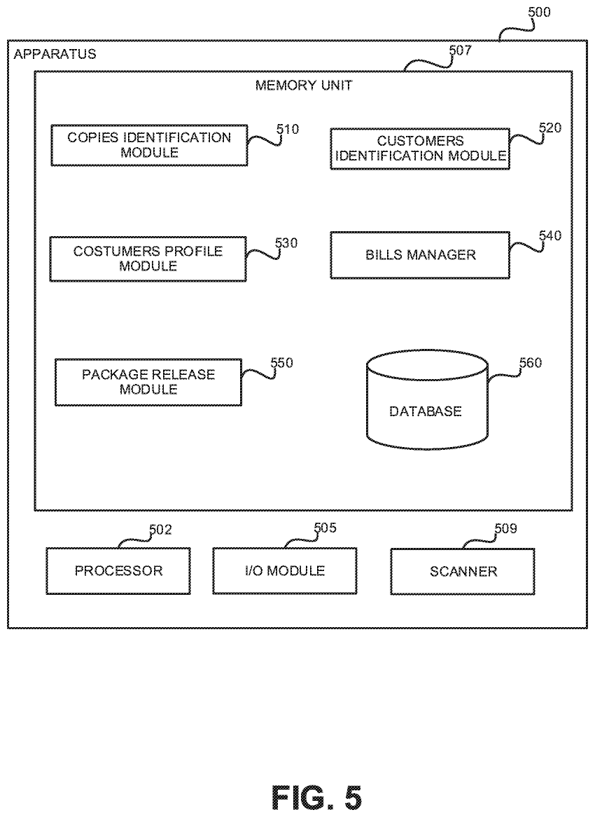

Referring now to FIG. 5 showing a block diagram of an apparatus, in accordance with some exemplary embodiments of the disclosed subject matter.

In some exemplary embodiments, Apparatus 500 may comprise one or more Processor(s) 502. Processor 502 may be a Central Processing Unit (CPU), a microprocessor, an electronic circuit, an Integrated Circuit (IC) or the like. Processor 502 may be utilized to perform computations required by Apparatus 500 or any of it subcomponents.

In some exemplary embodiments of the disclosed subject matter, Apparatus 500 may comprise an Input/Output (I/O) module 505. I/O Module 505 may be utilized to provide an output to and receive input from a user, such as, for example add items, quantities of items that are available, and prices of items to an inventory that may comprised by a Database 560. Additionally or alternatively, I/O Module 505 may be utilized to update a list of customers, their profiles, payment method, or the like. Additionally or alternatively, I/O Module may be utilized in order to send bills to costumers, obtain payment approval from a third payment service such as PAYPAL™, or the like.

In some exemplary embodiments, Apparatus 500 may comprise Memory Unit 507. Memory Unit 507 may be a hard disk drive, a Flash disk, a Random Access Memory (RAM), a memory chip, or the like. In some exemplary embodiments, Memory Unit 507 may retain program code operative to cause Processor 502 to perform acts associated with any of the subcomponents of Apparatus 500.

In some exemplary embodiments, a Scanner 509 may utilized to scan copies of that are being distributed to packages at the packaging zone. Scanner 509 may be configured to scan a bar code, a QR code, RFID tag, or the like. Additionally or alternatively, Scanner 509 may be configured to scan markers that were marked by a customer, such as scanning personal stickers affix to copies, scanning intermediate containers, or the like. In some exemplary embodiments, the sticker may be a RFID sticker. Scanner 509 may be an RFID reader.

Memory Unit 507 may comprise one or more components as detailed below, implemented as executables, libraries, static libraries, functions, or any other executable components.

In some exemplary embodiments, a Copies Identification Module 510 may be configured to identify a Copy. Copies Identification Module 510 may obtain the output of Scanner 509 and query Database 560 in order to retrieve the copy name, price, brand, or the like. Additionally or alternatively, Copies Identification Module 510 may receive the output of scanning an items.

In some exemplary embodiments, a Customers Identification Module 520 may be configured to identify a customer based on a mark that is associated with a copy. Customers Identification Module 520 obtain the output of Scanner 509 and may obtain from a Database 560 a unique identifier of the customer.

In some exemplary embodiments, a Customers Profile Module 530 may be configured to maintain a profile of a customer. The profile of the customer may comprise details of the customer such as the name of the customer, address of the customer, shipping address of the customer, discounts that the costumer may be entitled to, or the like. Additionally or alternatively, the profile of the customer may comprise preferences such as favorite items, favorite quantities, or the like. Additionally or alternatively, the profile of the passenger may comprise her response to sales. As an example, while the customer is in an aisle comprises copies of chocolate, the customer may receive an indication that a brand is on sale. Her response to the sale, whether she marked a copy of a chocolate item of that brand and how fast she marked may be recorded and save as part of her profile.

In some exemplary embodiments, a Bills Manager 540 may be configured to manage open bills that are currently maintained by Apparatus 500. In some exemplary embodiments, bills may be generated incrementally and Bills Manager 540 may update bills as items are being scanned by Scanner 509, identified by Copies Identification Module 510 and respective customers are identified by Customers Identification Module 520. Additionally or alternatively, Bills Manager 540 may be configured to produce a bill for a customer. Bill Manager 540 may obtain details of the costumer from Costumers Profile Module 530. Bills Manager 540 may obtain a list of discounts that the customer is entitled to and apply the discount on the bill. As an example, the customer may be entitled to a 1+1 discount on milk and to a 5% birthday discount on the total sum of the bill.

In some exemplary embodiments, Bill Manager 540 may be configured to generate a bill automatically. A price of each scanned item may be added to the associated customer. Bills manager 540 may obtain an indication for a scanning of the last item of a customer and send the bill to the customer. Sending the bill to a customer may comprise transmitting the bill to the customer. In some exemplary embodiments, the bill may be transmitted as an attachment in an e-mail to the customer's email address. Additionally or alternatively, the bill may be transmitted to an application. The application may be provided to the customer buy the supermarket. In some exemplary embodiments, the customer may configure the application to pay the bill automatically. The application may obtain the bill and automatically pay the bill without the customer intervention.

In some exemplary embodiments, a Package Release Module 550 may be configured to release a package to a costumer. Package Release Module 550 may be configured to obtain a payment approval from a payment service, from a payment module (not shown) that may be external to the apparatus, or the like. In response to obtaining the payment approval, Package Release Module 550 may be configured to release the package of the paying customer. In some exemplary embodiments, the released package may be dispatched to the customer, either manually or automatically.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method performed in a shopping environment,
wherein the shopping environment comprises a packaging zone and a shopping zone, wherein the shopping zone comprises a plurality of shelves in a plurality of aisles, wherein the shelves retain a multiplicity of identical copies of different items, wherein each different item is associated with an identifier, wherein each identical copy of the each different item is associated with the identifier, wherein a plurality of shared carts are located at different locations within the shopping zone, wherein the plurality of shared carts comprise a first cart and a second cart;
the method comprises:
marking, with a first sticker, a copy of a first item, wherein the copy of the first item is located on a shelf in a first aisle, wherein the first sticker identifies a customer;
transferring the copy of the first item to the first cart, wherein the first cart is located at or near the first aisle, wherein the first cart comprises a plurality of marked items, at least one of which is marked with a sticker identifying another customer different than the customer;
transferring items from the first cart to the packaging zone, whereby transferring the copy of the first item to the packaging zone;
distributing the items from the first cart to packages for different customers, wherein said distributing is performed based on stickers affixed to the items, wherein said distributing comprises adding the copy of the first item to a package of the customer;
marking, with a second sticker, a copy of a second item, wherein the copy of the second item is located on a shelf in a second aisle, wherein the second sticker identifies the first customer;
transferring items from the second cart to the packaging zone, whereby transferring the copy of the second item to the packaging zone;
distributing the items from the second cart to packages for different customers, wherein said distributing is performed based on stickers affixed to the items, wherein said distributing comprises adding the copy of the second item to the package of the customer, whereby incrementally preparing the package for the customer; and
providing the package to the customer, whereby the costumer is provided with a set of purchased items without carrying together the set of purchased items while moving within the shopping zone.

2. A method performed in a shopping environment,
wherein the shopping environment comprises a packaging zone, a plurality of shared intermediate zones and a shopping zone, wherein the shopping zone comprises a plurality of shelves in a plurality of aisles, wherein the shelves retain a multiplicity of copies of different items, wherein each different item is associated with an identifier, wherein each identical copy of the each different item is marked with the identifier;
the method comprises:
marking a copy of an item, wherein said marking identifies the copy of the item as being associated with a customer;
transferring the copy of the item to a shared intermediate zone, wherein the shared intermediate zone comprises a plurality of marked items, at least one of which is marked to be associated with another customer different than the customer;
transferring items from the shared intermediate zone to the packaging zone, whereby transferring the copy of the item to the packaging zone;
distributing the items from the shared intermediate zone to packages for different customers, wherein said distributing is performed based on the markings that identify customers associated with the items, wherein said distributing comprises adding the copy of the item to a package of the customer; and
providing the package to the customer.

3. The method of claim 2, wherein said marking comprises affixing a sticker to the copy of the item, wherein the sticker uniquely identifies the costumer.

4. The method of claim 2, wherein said marking comprises digitally marking the copy of the item in a digital repository, wherein said marking is performed using at least one of a code scanner and a camera, to identify the copy of the item, wherein the copy of the item is identified using the identifier that is marked thereon.

5. The method of claim 2, wherein said marking comprises placing the copy of the item in an intermediate container that is associated with the customer, wherein the shared intermediate zone is configured in size and shape to store a plurality of intermediate containers.

6. The method of claim 2, wherein the shared intermediate zone is a shared cart.

7. The method of claim 6, wherein said transferring the items from the shared intermediate zone to the packaging zone comprises transferring the shared cart from a location in the shopping zone to the packaging zone.

8. The method of claim 6 further comprises periodically transferring loaded shared carts from the shopping zone to the packaging zone, unloading the shared shopping cars in the packaging zone and transferring unloaded shared carts from the packaging zone to the shopping zone.

9. The method of claim 2, wherein the shared intermediate zone is a conveyor belt.

10. The method of claim 2, wherein said transferring the copy of the item to the shared intermediate zone is performed by a robotic arm that is configured to pick up the copy of the item from a shelf and transfer the copy of the item to the shared intermediate zone.

11. The method of claim 2, wherein said providing comprises: providing the package to the customer within the shopping environment, wherein said providing is performed in response to a payment of a bill by the customer, wherein the bill is generated automatically.

12. The method of claim 2, wherein said providing comprises: delivering the package to an external address of the customer, wherein the package comprises copies of items selected by the customer while the customer is physically located in the shopping zone.

13. The method of claim 2, wherein the plurality of aisles comprise at least one aisle that has an aisle spacing that is no more than 120 centimeters.

14. A method performed in a shopping environment,
wherein the shopping environment comprises a packaging zone, a plurality of shared intermediate containers and a shopping zone, wherein the shopping zone comprises a plurality of shelves in a plurality of aisles, wherein the shelves retain a multiplicity of copies of different items, wherein each different item is associated with an identifier, wherein for at least a portion of the each different item, each identical copy thereof is marked with the identifier;
the method comprises:
transferring a first shared intermediate container from the shopping zone to the packaging zone, wherein the first shared intermediate container comprises at least a first copy of a first item and a second copy of the first item, wherein the first copy of the first item is associated, using a marking, with a first customer, wherein the second copy of the first item is associated, using a marking, with a second customer;
unloading the first shared intermediate container into packages, wherein said unloading comprises identifying an associated customer for each item in the first shared intermediate container, wherein said unloading comprises placing each item in a package associated with the associated customer, wherein based on said identifying the associated customer, updating a list of purchased items of the associated customer to include the each item, whereby placing the first copy of the first item in a first package that is associated with the first customer and updating a first list of purchased items of the first customer to include the first item, whereby placing the second copy of the first item in a second package that is associated with the second customer and updating a second list of purchased items of the second customer to include the first item;
transferring a second shared intermediate container from the shopping zone to the packaging zone, wherein the second shared intermediate container comprises at least a copy of a second item, wherein the copy of the second item is associated, using a marking, with the first customer;
unloading the second shared intermediate container into packages, wherein said unloading comprises identifying an associated customer for each item in the second shared intermediate container, wherein said unloading comprises placing each item in a package associated with the associated customer, wherein based on said identifying the associated customer, updating a list purchased items of the associated customer to include the each item, whereby placing the copy of the second item in the first package and updating the first shopping list to include the second item;
transferring a third shared intermediate container from the shopping zone to the packaging zone, wherein the third shared intermediate container comprises at least a copy of a third item, wherein the copy of the third item is associated, using a marking, with the second customer;
unloading the third shared intermediate container into packages, wherein said unloading comprises identifying an associated customer for each item in the third shared intermediate container, wherein said unloading comprises placing each item in a package associated with the associated customer, wherein based on said identifying the associated customer, updating a list of purchased items of the associated customer to include the each item, whereby placing the copy of the third item in the second package and updating the second list of purchased items to include the third item;
receiving payment from the first customer based on the first list of purchased items;
providing the first package to the first customer;
receiving payment from the second customer based on the second list of purchased items; and
providing the second package to the second customer.

15. A system comprising:
a shopping zone, wherein the shopping zone comprises a multiplicity of identical copies of different items, wherein each different item is associated with an identifier, wherein for at least a portion of the different items, each identical copy of each different item in the portion is marked with the identifier;
a marking means for enabling a customer to mark a copy of an item in the shopping zone to associate the marked copy with the customer;
a plurality of shared intermediate zones spread across the shopping zone, wherein each shared intermediate zone is configured to temporarily retain a plurality of marked copies of different customers at the same time, wherein a plurality of marked copies associated with the customer are distributed in two or more shared intermediate zones; and
a packaging zone comprising a package associated with the customer, wherein the plurality of marked copies are added into the package after being transferred from the plurality of shared intermediate zones to the packaging zone.

16. The system of claim 15, wherein the plurality of shared intermediate zones comprise a plurality of shared carts.

17. The system of claim 15 further comprises a scanning means for scanning a marked copy of an item to retrieve an associated customer thereof, wherein said scanning means is operatively coupled to a billing system that is configured to update a list of purchased items of the associated customer.

18. The system of claim 15 further comprises a plurality of robotic devices for transferring marked copies of items from the shopping zone to the plurality of shared intermediate zones.

19. The system of claim 15, wherein the system is absent of shopping carts that are uniquely associated with a specific customer during a shopping session.
